(19) United States
(12) Patent Application Publication
(10) Pub. No.: US 2026/0140973 A1
(43) Pub. Date: May 21, 2026

(54) EMBEDDING CONTENT ON A PRIMARY OBJECT OF GENERATED CONTENT

(71) Applicant: Motorola Mobility LLC, Chicago, IL (US)

(72) Inventors: Amit Kumar Agrawal, Bangalore (IN); Bill Ryan, Libertyville, IL (US); Krishnan Raghavan, Bangalore (IN); Nakul Patel, Bangalore (IN)

(73) Assignee: Motorola Mobility LLC, Chicago, IL (US)

(21) Appl. No.: 18/951,065

(22) Filed: Nov. 18, 2024

(51) Int. Cl. G06F 16/332; G06F 16/338

(52) U.S. Cl. CPC G06F 16/3329; G06F 16/338

(57) ABSTRACT

In accordance with the described techniques, a content generation query is received, and a primary object of the content generation query is identified. Further, a content element associated with the primary object is retrieved from a content database. Based on the content generation query, a generative artificial intelligence (AI) model is prompted to generate content by embedding the content element on the primary object of the generated content. The generated content is then displayed in a user interface.

### BACKGROUND

Generative artificial intelligence (AI) refers to a class of machine learning models designed to create content, such as images, text, audio, or video, based on input data. These models learn patterns from large datasets and use them to generate novel outputs. Popular applications of generative AI include text-to-image models, which create realistic or artistic images from textual descriptions. In addition to creative fields, generative AI is used for tasks such as image restoration, data augmentation, and simulating real-world environments. The ability of generative AI to produce high-quality, personalized content has made it a valuable tool across industries like entertainment, design, and more

### BRIEF DESCRIPTION OF THE DRAWINGS

Aspects of embedding content on a primary object of generated content are described with reference to the following Figures. The same numbers may be used throughout to reference similar features and components that are shown in the Figures. Further, identical numbers followed by different letters reference different instances of features and components described herein.

FIG. 1 illustrates an example environment in which embedding content on a primary object of generated content can be implemented;

FIG. 2 illustrates an example system for embedding content on a primary object of generated content;

FIG. 3 depicts an example user interface of embedding content on a primary object of generated content;

FIG. 4 depicts an example user interface of embedding content on a primary object of generated content;

FIG. 5 illustrates a flow chart depicting an example method of embedding content on a primary object of generated content in accordance with one or more implementations;

FIG. 6 illustrates a flow chart depicting an example method of embedding content on a primary object of generated content in accordance with one or more implementations;

FIG. 7 illustrates various components of an example device in which aspects of embedding content on a primary object of generated content can be implemented in accordance with one or more implementations.

### DETAILED DESCRIPTION

The techniques described herein relate to embedding pre-generated content elements into user-requested content, such as generated by a generative artificial intelligence (AI) model. By way of example, a user provides a content generation query via a user interface which provides information, instructions, and/or context to the generative AI model for the purpose of generating content. In accordance with pre-generated content integration, one or more pre-generated content elements are retrieved from a content database for integration into content generated by the generative AI model based on the content generation query. However, conventional techniques fail to select contextually relevant content for integration and/or the integrated content elements are disjointed with respect to the generated content as a whole, which can lead to a poor user experience and frustration.

To alleviate these inconveniences, techniques for embedding content on a primary object of generated content are discussed herein. In accordance with the described techniques, a content generation query is received. By way of example, a user inputs the content generation query (e.g., a text-to-image query) via a user interface, and the content generation query is received by a content embedding system. The content embedding system is configured to analyze the content generation query, and extract a primary object from the content generation query. Generally, the primary object is a significant and/or central element of the content generation prompt that is to be generated as part of the generated content. In one example in which the content generation prompt is “generate an image of a stunning red car along an ocean drive,” the primary object is “car.” In addition, the content embedding system identifies candidate placements where content elements are embeddable on the primary object. The candidate placements can be the primary object as a whole and/or components of the primary object.

Furthermore, the content embedding system maintains a content database containing a plurality of content elements, e.g., logos or icons of brands, logos or icons of professional sports teams, etc. In one example, each content element is paired with one or more tags in the content database. Here, the content embedding system queries the content database with the candidate placements, and the content database returns the content elements paired with the candidate placements as tags in the content database. In the context of branded content elements (e.g., brand logos or icons), the content embedding system additionally retrieves brand information (e.g., promotions, brand voice, endorsements, campaign objectives, and sponsorships of the brand) paired with the brand in the content database. In addition, the content embedding system retrieves user data associated with the user that submitted the content generation query, e.g., user preferences, user interests, demographic data. Furthermore, the content embedding system obtains an environmental context associated with the user, e.g., geographical location of the user, time of day, weather conditions, local events near the user, etc.

The content embedding system is configured to select a particular content element from the retrieved content elements and a selected placement from the candidate placements on which to embed the particular content element. To do so, the content embedding system utilizes a machine learning model in one or more implementations. For example, the machine learning model is trained and/or prompted to select, from the retrieved content elements, a particular content element that is most relevant to the content generation query, the brand information, the user data, and/or the environmental context. In addition, the machine learning model is trained and/or prompted to select, from the candidate placements, a particular placement exhibiting a highest degree of relevance to the content generation query.

In one or more implementations, the content embedding system builds a prompt that includes the content generation query, indications of the primary object, the selected content element, and the selected placement on the primary object. Next, the prompt is fed to the generative AI model, which creates generated content. In particular, the generative AI model generates content in accordance with the content generation query, and embeds the selected content element on the selected placement of the primary object. In one or more implementations, the device implementing the content embedding system includes a local instance of the generative AI model stored thereon, and the local instance of the generative AI model creates the generated content. In variations, the device communicates the prompt to an additional device having increased memory and/or processing resources in comparison to the device. In these scenarios, the additional device creates the generated content, and communicates the generated content back to the device for display.

Thus, the described techniques extract primary objects from a content generation query, and retrieve content elements that are associated with and/or relevant to the primary object and/or components thereof. In addition, the described techniques select a particular content element for integration based on the user data (e.g., the user's interests, preferences, demographics, and the like), an environmental context associated with the user, and/or brand information of branded content elements. Moreover, the described techniques embed the selected content element on the primary object, rather than some element of the background that is unrelated to the content generation query. Accordingly, the described techniques improve upon conventional techniques for pre-generated content integration by increasing the contextual relevance of the selected content element being integrated and integrating the selected content element in a seamless and cohesive manner. This improves user satisfaction with the generated content, which reduces content regeneration attempts at the generative AI model. Indeed, due to increased satisfaction with the generated content, the user is less likely to prompt the generative AI model to create new and/or additional content, which conserves computational resources and improves computational efficiency at the computing device implementing the generative AI model.

In addition, the described techniques relate to offloading the content generation task to an additional device having increased processing and/or memory resources. For instance, the additional device is equipped with accelerator devices designed to speed up execution of machine learning workloads (e.g., neural processing units (NPUs), inference processors, and the like), while the device is not equipped with such accelerator devices. By offloading the content generation task to the additional device in the manner described, the described techniques enable and/or speed up the process of producing the generated content.

While features and concepts of embedding content on a primary object of generated content can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

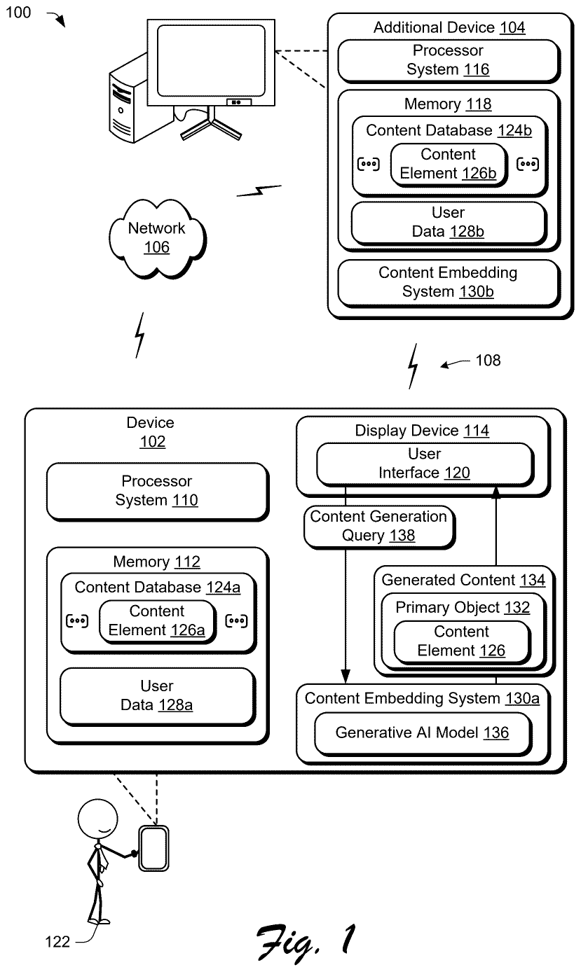

FIG. 1 illustrates an example environment 100 in which aspects of a embedding content on a primary object of generated content can be implemented. The environment 100 includes a device 102 and an additional device 104 that are communicatively coupled over a network 106, such as a Wi-Fi network or a cellular network. Additionally or alternatively, the device 102 and the additional device 104 are communicatively coupled via a peer-to-peer connection 108 examples of which include a Bluetooth connection, a Bluetooth Low Energy (BLE) connection, a Wi-Fi Direct connection, a Near-Field Communication (NFC), an ultra-wideband (UWB), and/or a wired connection. Computing devices that implement the device 102 and the additional device 104 are configurable in a variety of ways. A computing device, for instance, is configurable as a desktop computer, a laptop computer, a mobile device (e.g., assuming a handheld configuration such as a tablet or mobile phone), one or more server devices, and so forth. Thus, a computing device ranges from full resource devices with substantial memory and processor resources (e.g., personal computers, game consoles, server devices) to a low-resource device with limited memory and/or processing resources (e.g., mobile devices). In at least one specific but non-limiting example, the device 102 is a mobile device (e.g., a smartphone) and the additional device 104 is a personal desktop computer, as shown.

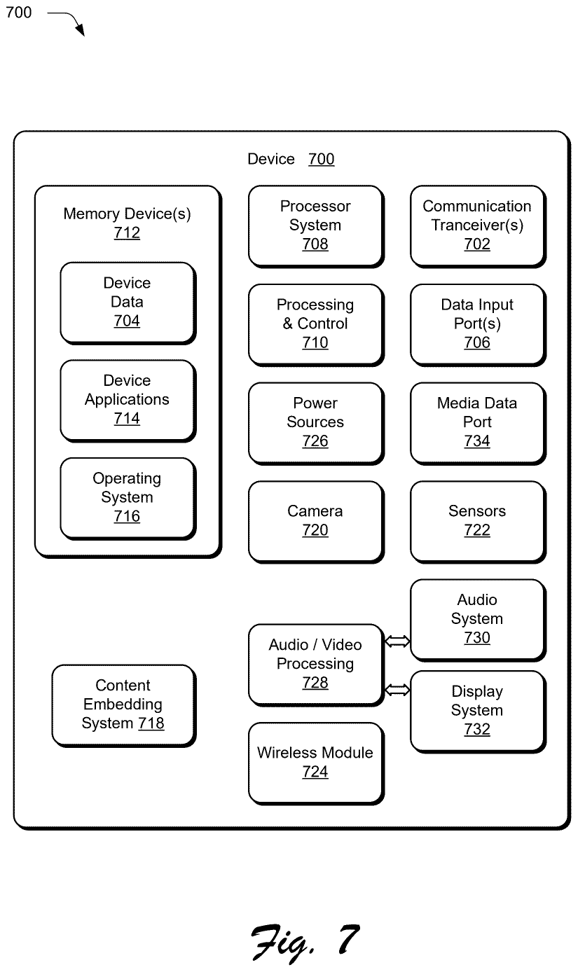

In one or more examples, the device 102 is implemented with various hardware components, such as a processor system 110, a memory 112, and a display device 114. In addition, the additional device 102 is implemented with a processor system 116 and a memory 118. Broadly, the processor system 110, 116 is representative of one or more processors configured to process computer-executable instructions. Moreover, the memory 112, 118 is a system or device that enables storage of data. The memory 112, 118 can include non-volatile memory (e.g., read-only memory (ROM), flash memory, solid-state drives, etc.) and volatile memory, e.g., random access memory (RAM) dynamic random access memory (DRAM), static random access memory (SRAM), etc. The display device 114 is representative of functionality for output of graphical content via the device 102, e.g., in a user interface 120 of the display device 114. The device 102 and the additional device 104 are also implemented with any number and any combination of different components, as further discussed below with reference to the example device 700 of FIG. 7.

As shown, the device 102 includes a content database 124a maintained in the memory 112, and the content database 124a includes a plurality of content elements 126a. Additionally or alternatively, the additional device 104 includes a content database 124b maintained in the memory 118, and the content database 124b includes a plurality of content elements 126b. Broadly, the content elements 126 are pre-generated image content elements and/or pre-generated video content elements to be integrated into generated content as generated by a generative artificial intelligence (AI) model. The content elements 126 are configurable in a variety of ways. In one or more implementations, the content elements 126 include branded content of a plurality of brands, such as brand logos, brand icons, products offered for sale by respective brands, brand advertisements, brand commercials, brand promotions, and the like. Additionally or alternatively, the content elements 126 include logos or icons of professional sports teams, representations (e.g., avatars) of people (e.g., athletes, musicians, celebrities) or characters (e.g., movie, television, and video game characters), university and school logos, seals, and crests, locale-related content (e.g., state or national flags, regional emblems, city seals and logos, cultural symbols and icons), and so on.

In addition, the device 102 includes user data 128a maintained in memory 112 and/or the additional device 104 includes user data 128b maintained in memory 118. Broadly, the user data 128 includes information associated with the user 122 (e.g., the owner and/or registered user of the device 102), such as preferences of the user 122, interests of the user 122, and demographics of the user 122. Examples of user preferences include content modality preferences (e.g., whether the user 122 prefers content to be output in image, video, and/or audio format) and visual content consumption preferences, e.g., whether the user 122 prefers to consume visual content that is bright or dark in color, simple or elegant in design, dense or spacious in layout, and so on. Examples of user interests include hobbies of the user 122 (e.g., gaming, fitness, and fashion), entertainment (e.g., movies, TV shows, books, and characters), sports (e.g., sports teams and players), and so on. Example user demographics include age, gender, income level, occupation, family status, ethnicity, etc. The user data 128 is collectable using any one or more of a variety of public or proprietary techniques and/or sources, examples include web tracking, interaction and engagement data tracking, search history and query collection, social media activity analysis, and so on.

Although illustrated as stored locally in the memory 112, 118 of the device 102 and the additional device 104, respectively, it is to be appreciated that the content elements 126 and/or the user data 128 are stored at a remote service provider system (not depicted). By way of example, the remote service provider system is implemented by one or more server devices and is configured to provide resources, data, and applications to the device 102 and/or the additional device 104, such as over a “cloud.” As part of this, the remote service provider system maintains the content database 124 including the plurality of content elements 126, as well as the user data 128 for the user 122 and/or a plurality of other users. The remote service provider system, for instance, maintains a plurality of user profiles containing the user data of different users, and optionally, categorizes the plurality of users into segments using profiling and segmentation techniques. In this way, the device 102 and/or the additional device 104 can retrieve data (e.g., content element(s) 126 and user data 128) upon request to the remote service provider system. By way of example, the device 102 and/or the additional device 104 communicates a request for data over the network 106 to the remote service provider system, and in response, the remote service provider system returns the requested content elements 126 and/or user data 128.

In accordance with the described techniques, the device 102 includes a content embedding system 130a and/or the additional device 104 includes a content embedding system 130b. Broadly, the content embedding system 130 is representative of functionality for embedding a content element 126 on a primary object 132 of generated content 134 as generated by a generative AI model 136. To do so, the user 122 provides user input specifying a content generation query 138 via the user interface 120. Broadly, the content generation query 138 is a natural language request submitted by the user 122 providing information and/or instructions to the generative AI model 136 for creating the generated content 134. An example of a content generation query 138 is “generate an image of a stunning red car along an ocean drive.” Although the generated content 134 is depicted and described herein as generated by the generative AI model 136, it is to be appreciated that the generated content 134 is generated using any one or more of a variety of techniques and/or methods, examples of which include web scraping, database content retrieval (e.g., from stock image/video databases), and/or API-based content retrieval, e.g., from content repositories available at web sources.

Upon receiving the content generation query 138, the content embedding system is configured to analyze the content generation query 138 to identify a primary object 132 of the content generation query 138. Generally, the primary object 132 is a significant and/or central element of the content generation prompt 136 that is to be generated as part of the generated content 134. In the context of the previous example in which the content generation query 138 is “generate an image of a stunning red car along an ocean drive,” the primary object 132 is “car.”

Responsive to identifying the primary object 132, the content embedding system 130 is configured to retrieve a plurality of content elements 126 associated with (e.g., relevant to) the primary object 132 from the content database 124. Continuing with the previous example in which the primary object 132 is “car,” the retrieved content elements 126 can include a plurality of brand logos of different car brands. In an additional example in which the primary object 132 is “basketball player,” the retrieved content elements 126 can include a plurality of team logos of different professional basketball teams. As further discussed below, the retrieved content elements 126 can be related to the primary object 132 itself or components of the primary object 132. In addition, the content embedding system 130 is configured to retrieve the user data 128 associated with the user 122. As previously mentioned, the content embedding system 130 can retrieve the relevant content elements 126 and the user data 128 from a local memory resource (e.g., the memory 112 or the memory 118), or the content embedding system 130 can retrieve the relevant content elements 126 and the user data 128 from the remote service provider system.

Based at least in part on the user data 128, the content embedding system 130 selects a particular content element 126 from the retrieved content elements 126. In the context of a primary object 132 detected as a car, the content embedding system 130 selects a brand logo of a particular car brand from a plurality of brand logos of a plurality of car brands based on the user data. For example, the particular brand logo is associated with an affordable car brand (based on the user data 128 indicating demographic information of a relatively low income level) or a luxury car brand (based on the user data 128 indicating demographic information of a relatively high income level). In the context of a primary object 132 detected as a basketball player, for example, the content embedding system 130 selects a particular basketball team logo from a plurality of basketball team logos. Here, the particular team logo is associated with a professional basketball team that the user 122 follows, e.g., as indicated by the user interests of the user data 128.

Next, the content embedding system 130 prompts the generative AI model 136 to generate content, in part, by embedding the selected content element 126 on the primary object of the generated content 134. Broadly, the generative AI model 136 is a machine learning model trained to generate image content, video content, and/or audio content based on a prompt that includes the content generation query 138 and/or additional conditioning signals such as the content element 126 and an indication of the primary object 132. In various examples, the generative AI model 136 includes, but is not limited to including, generative adversarial networks (GANs), style transfer models (e.g., styleGAN), variational autoencoders, inpainting models, and diffusion models. In various examples, the generative AI model 136 includes or corresponds to a web platform that integrates a pre-trained large language model (LLM) (e.g., a generative pre-trained transformer (GPT-3) model) and a pre-trained multimodal model (e.g., a DALL-E 3 model), to process inputs and outputs in different content modalities, e.g., image, text, video, and/or audio.

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

In accordance with the described techniques, the content embedding system 130 generates a prompt that includes the content generation query 138, an indication of the primary object 132, and the selected content element 126. The prompt instructs the generative AI model 136 to embed the selected content element 126 on the primary object 132. Thus, based on the prompt, the generative AI model 136 produces generated content 134 in accordance with the content generation query 138 such that the selected content element 126 is embedded on the primary object 132.

In one or more implementations, the device 102 is configured to produce the generated content 134 locally at the device 102. For example, the device 102 includes the generative AI model 136 (e.g., maintained in memory 112), and the device 102 leverages the content embedding system 130a and the generative AI model 136 to produce the generated content 134 at the device 102. In this example, the content generation query 138 is generated at the device 102, the prompt is generated at the device 102, the generated content 134 is created at the device 102, and the generated content 134 is displayed all at the device 102.

Additionally or alternatively, the device 102 employs the additional device 104 to produce the generated content 134. In various scenarios, for instance, the additional device 104 is configured with increased processing and/or memory resources as compared to the device 102. For example, the additional device 104 includes increased memory capacity as compared to the device 102, and as such, the generative AI model 136 is capable of being stored at the additional device 104 but not the device 102. In another example, the additional device 104 includes additional and/or more processing resources than the device 102, and as such, implementing the generative AI model 136 at the additional device 104 reduces content generation latency, e.g., a time between when the content generation query 138 is submitted and when the generated content 134 is output for display. For instance, the additional device 104 is equipped with accelerator devices designed to speed up execution of machine learning workloads (e.g., neural processing units (NPUs), inference processors, and the like), while the device 102 is not equipped with such accelerator devices. This enables the additional device 104 to produce the generated content 134 using the generative AI model 136 significantly faster than the device 102.

Accordingly, in various implementations, the device 102 is configured to offload the content generation task to the additional device 104. In one example, the device 102 receives the content generation query 138 and leverages the content embedding system 130a to identify the primary object 132, select the content element 126 for embedding, and generate the prompt. Further, the device 102 communicates the prompt to the additional device 104. Here, the additional device 104 leverages the generative AI model 136 (e.g., maintained in memory 118 of the additional device 104) to produce the generated content 134 based on the prompt, and communicates the generated content 134 back to the device 102 for display in the user interface 120. In other words, the content generation query 138 is received at the device 102, the prompt is generated at the device 102, the generated content 134 is created at the additional device 104, and the generated content 134 is displayed at the device 102.

In another example, the device 102 receives the content generation query 138 and communicates the content generation query 138 to the additional device 104. Here, the additional device 104 employs the content embedding system 130b and the generative AI model 136 (e.g., maintained in memory 118 of the additional device 104) to identify the primary object 132, select the content element 126 for embedding, generate the prompt, create the generated content 134 using the generative AI model 136, and communicate the generated content 134 back to the device 102 for display. In other words, the content generation query 138 is received at the device 102, the prompt is generated at the additional device 104, the generated content 134 is created at the additional device 104, and the generated content 134 is displayed at the device 102.

By offloading the content generation task to the additional device 104 in the manner described, the described techniques enable and/or speed up the process of producing the generated content 134. In an example in which there is insufficient memory 112 to store the generative AI model 136 at the device 102, for instance, the described offloading techniques enable the additional device 104 to create the generated content 134 for presentation at the device 102. In another example in which the additional device 104 includes increased processing capabilities as compared to the device 102, the described offloading techniques reduce the content generation latency as compared to producing the generated content 134 at the device 102.

In yet another example, an instance of the content embedding system 130 is implemented at the remote service provider system, which provides the functionality and resources of the content embedding system 130 to the device 102 over the cloud. For example, the device 102 receives the content generation query 138 and communicates the content generation query 138 to the remote service provider system. Here, the remote service provider system employs the content embedding system 130 and the generative AI model 136 (e.g., implemented at the remote service provider system) to identify the primary object 132, select the content element 126 for embedding, generate the prompt, create the generated content 134 using the generative AI model 136, and communicate the generated content 134 back to the device 102 for display.

Having discussed an example environment in which the disclosed techniques can be performed, consider now some example scenarios and implementation details for implementing the disclosed techniques.

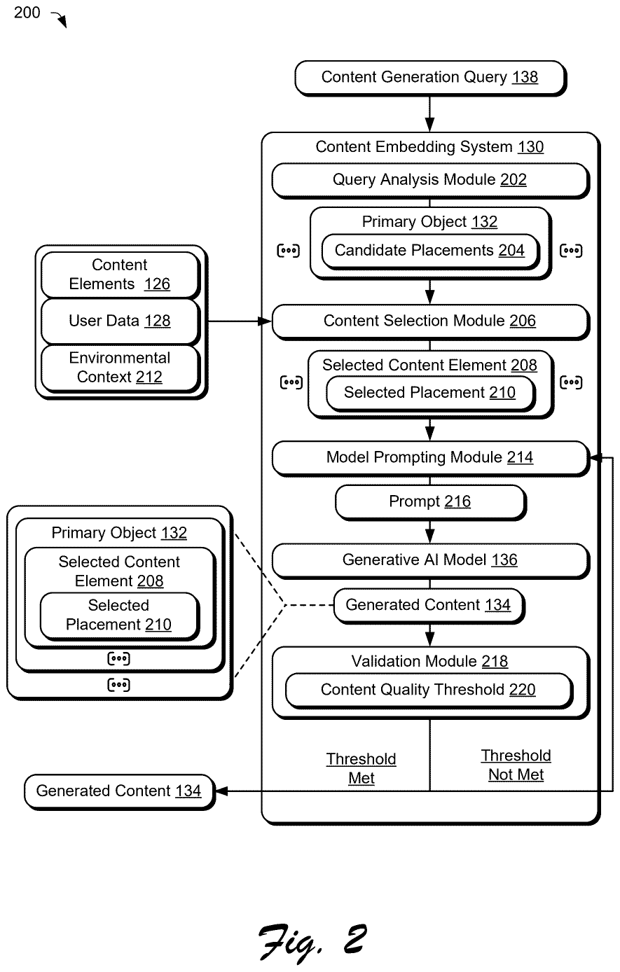

FIG. 2 illustrates an example system 200 for embedding content on a primary object of generated content. In the system 200, a content embedding system 130 is configured to receive a content generation query 138, e.g., as input by the user 122 via the user interface 120. In variations, the content embedding system 130 of the system 200 is the content embedding system 130a of the device 102, the content embedding system 130b of the additional device 104, or an instance of the content embedding system 130 implemented by the remote service provider system, as discussed above.

As shown, the content embedding system 130 includes a query analysis module 202 which is representative of functionality for extracting one or more primary objects 132 from the content generation query 138. Additionally, the query analysis module 202 is configured to identify, for each primary object 132, one or more candidate placements 204 on the primary object 132 where content elements 126 are embeddable. As previously mentioned, the primary object 132 is a significant and/or central element of the content generation query 138, and there can be more than one primary object 132 in a single content generation query 138. The candidate placements 204 include the primary object 132 as a whole, and components of the primary object 132. In an example of a “car” as a primary object 132, for instance, the candidate placements 204 include the car as a whole, tires of the car, a grill of the car, an exhaust pipe of the car, an engine of the car, and so on. Additionally or alternatively, the candidate placements 204 include components that are non-essential for fully illustrating the primary object 132 but can be added, superimposed, and/or integrated as part of the primary object 132. In an example of a “cat” as a primary object, for instance, the cat can be made to wear a jacket, shoes, and sunglasses. Accordingly, the candidate placements 204 include jacket, shoes, and sunglasses to be worn by the cat even though the final generated content 134 may not include each of the jacket, the shoes, and the sunglasses.

Any one or more of a variety of public or proprietary natural language processing (NLP) techniques are usable by the query analysis module 202 to extract the primary objects 132 and the candidate placements 204 thereon. Example techniques include named entity recognition (NER), keyword extraction, semantic analysis, part-of-speech (POS) tagging, and the like. Additionally or alternatively, the query analysis module 202 leverages an LLM that has been pre-trained to perform a variety of NLP tasks, such as query and/or prompt answering, examples of which include generative pre-trained transformer (GPT) models, text-to-text transfer (T5) models, bidirectional encoder representations from transformers (BERT) models, and the like. By way of example, the query analysis module 202 communicates with the LLM using an application programming interface (API) to prompt the LLM to extract the primary objects 132 from the content generation query 138, and/or identify the candidate placements 204 thereon.

As shown, the primary objects 132 and the candidate placements 204 are provided to a content selection module 206. Broadly, the content selection module 206 is representative of functionality for selecting one or more content elements 126 (e.g., selected content elements 208) to embed on the primary object 132. The content selection module 206 is further configured to select, for each selected content element 208, a placement from the candidate placements 204 (e.g., the selected placement 210) on which to embed the selected content element 208.

As part of this, the content selection module 206 retrieves a plurality of content elements 126 associated with the primary object(s) 132 from the content database 124. In one or more examples, each content element 126 in the content database 124 is paired with a set of tags associated with the content element 126. Tags, for instance, are key words or key phrases associated with the content element 126. In the context of an example in which the content element 126 is a brand logo, the tags paired with the brand logo include products or services offered by the brand. For instance, a fashion brand logo is paired with tags describing types of clothing products that the fashion brand offers, such as “shirt,” “shoes,” “jacket,” and so on. In the context of an example in which the content element 126 is a logo of a sports team, examples of tags include the city where the sports team is located, the particular sport that the team plays, the mascot of the team, and so on.

Given this, the content selection module 206 queries the content database with the candidate placements 204, e.g., the primary object 132 and the components of the primary object 132. In response, the content database 124 returns the content elements 126 that are paired with the candidate placements 204 as tags in the content database 124. In an example in which the candidate placements 204 include “jacket,” for instance, the retrieved content elements 126 include content elements 126 that are paired with the tag “jacket” in the content database 124. In this way, the content selection module 206 retrieves content elements 126 that are relevant to the primary object 132.

In addition, the content selection module 206 obtains the user data 128 associated with the user 122 submitting the content generation query 138. For example, the content selection module 206 retrieves the user data 128 contained within a user profile of the user 122 and/or retrieves the user data 128 of a segment of users to which the user 122 belongs. Additionally or alternatively, the content selection module 206 obtains an environmental context 212 associated with the user. Broadly, the environmental context 212 includes external factors and conditions surrounding the user 122 that impact the relevance of the retrieved content elements 126. For example, the environmental context 212 includes a geographic location of the user 122 (e.g., as obtained from GPS sensors of the device 102), a time of day, seasonality, weather conditions, local events or promotions happening near the user's location, and so on.

In one or more examples, the retrieved content elements 126 include branded content (e.g., brand logos, brand icons, brand advertisements, brand promotions, brand commercials, etc.) of a plurality of brands. As part of retrieving the branded content elements 126, the content selection module 206 is configured to retrieve information associated with the brand from the content database 124. For example, each branded content element 126 is paired with brand information in the content database 124, and the content selection module 206 retrieves the brand information as part of retrieving the branded content element 126. Examples of brand information of a branded content element 126 include promotions offered by a corresponding brand, a brand voice of the corresponding brand (e.g., a statement of the unique personality, tone, and style that a brand consistently uses to communicate with the brand's audience, reflecting the brand's values, mission, and identity), endorsements of the corresponding brand (e.g., indications of public figures, like celebrities or influencers, that promote the brand by expressing personal approval of the brand's products or services), campaign objectives of the corresponding brand (e.g., goals of the brand's advertising campaign, such as increasing brand awareness, generating leads, enhancing customer engagement, or promoting a new product or service), and sponsorships of the brand, e.g., events, organizations, and political campaigns that the brand provides financial or other support to for the purpose of enhancing brand visibility.

Broadly, the content selection module 206 is configured to output the selected content element 208 from the retrieved content elements 126, and output the selected placement 210 for each content element 208 from the candidate placements 204. This selection is based on the user data 128, the environmental context 212, the content generation query 138, and/or the brand information of the corresponding brands. In various examples, the content selection module 206 employs a machine learning model for this task. In one or more implementations, the content selection module 206 communicates (via an API) with a web platform that integrates a pre-trained LLM and a multimodal model, to process inputs and outputs in different content modalities, e.g., image, text, video, and/or audio. As part of this, the content selection module 206 prompts the web platform to select a content element from the retrieved content elements, and select a placement from the candidate placements 204 based on the user data 128, the environmental context 212, the content generation query 138, and/or the brand information.

For example, the content selection module 206 populates a first preconfigured prompt with indications of the retrieved content elements 126, the user data 128, the environmental context 212, the content generation query 138, and/or the brand information. In this example, the first preconfigured prompt instructs the web platform to select a particular content element from the retrieved content elements 126 that exhibits a highest degree of relevance to the user data 128, the environmental context 212, the content generation query 138, and/or the brand information. Here, the content selection module 206 feeds the first preconfigured prompt as populated with the above-noted information to the web platform, which returns the selected content element 208.

In one or more implementations, the first preconfigured prompt includes specific instructions for processing the brand information. These instructions may direct the platform to select a branded content element 126 based on (1) whether the brand information includes promotional offers that are relevant to the content generation query 138 (e.g., promotional offers for the primary object 132 or the candidate placements 204) or the user data 128, (2) whether the brand information includes a brand voice that aligns with the content generation query 138 or the user data 128, (3) whether the brand information includes endorsements of the brand that are relevant to the user interests of the user data 128, (4), whether surfacing the branded content element 126 to the user 122 will further the campaign objectives of the brand based on the user data 128, and (5) whether the brand information includes sponsorships that are relevant to the user data 128.

Furthermore, the content selection module 206 populates a second preconfigured prompt with indications of the candidate placements 204 and the selected content element 208. In this example, the second preconfigured prompt instructs the web platform to select a particular placement from the candidate placement 204 that exhibits a highest degree of relevance to the selected content element 208. Here, the content selection module 206 feeds the second preconfigured prompt as populated with the above-noted information to the web platform, which returns the selected placement 210.

In a different example, a machine learning model is specifically trained and/or finetuned on a dataset for the purpose of outputting the selected content elements 208 and the selected placements 210 thereon. Here, the training dataset includes a plurality of training samples, each including training input data and corresponding labels. The training input data of a training sample includes a content generation query 138, a set of content elements 126, brand information of branded content elements 126 in the set, user data 128 of a user, and an environmental context 212. Further, the corresponding labels include ground truth content elements that are selected by human annotators as most relevant to the brand information (e.g., considering factors (1)-(5) indicated above), user data 128, the environmental context 212, and/or the content generation query 138. In addition, the corresponding labels include a ground truth placement on each ground truth content element that is selected by human annotators as most relevant to the ground truth content element.

During training, the machine learning model is fed a training sample. Based on the training input data of the training sample, the machine learning model outputs one or more selected content elements 208 and a selected placement 210 on each selected content element 208. Furthermore, a loss function is leveraged to determine a loss between the selected content elements 208 and the ground truth content elements, as well as between the selected placements 210 and the ground truth placements. In one or more implementations, one or more vectorization techniques are employed to vectorize the selected content elements 208, the selected placements 210, the ground truth content elements, and the ground truth placements in a common embedding space. In this way, the loss is computable based on distances (e.g., Euclidean distance) between the selected content elements 208 and the ground truth content elements, as well as between the selected placements 210 and the ground truth placements. Parameters (e.g., internal weights) of the machine learning model are updated to minimize the loss. This process is repeated on different training samples until a threshold number of training samples are processed, a threshold number of epochs are processed, or the loss converges to a minimum. In this way, the machine learning model learns to select content elements, and placements thereon that reflect the ground truth content elements and placements in the training data.

As shown, the model prompting module 214 receives the selected content elements 208 and the selected placements 210 thereon. Although not shown, the model prompting module 214 additionally receives the content generation query 138, and indications of the primary objects 132. Here, the model prompting module 214 generates a prompt by populating a preconfigured prompt with the primary objects 132, the selected content elements 208, the selected placements 210, and the content generation query 138. For example, the prompt 216 instructs the generative AI model 136 to generate content in accordance with the content generation query 138. Given a primary object 132, the prompt 216 additionally instructs the generative AI model 136 to embed the selected content elements 208 on the selected placements 210 of the primary object 132.

In response to the prompt 216, the generative AI model 136 creates generated content 134. As shown, the generated content 134 includes one or more primary objects 132. For each primary object 132, the generated content 134 includes one or more selected content elements 208 embedded thereon. In particular, each selected content element 208 is embedded on a placement on the primary object 132 that is selected for the selected content element 208, e.g., the selected placement 210. In various examples, the generated content 134 is generated in accordance with a style of the selected content element 208. Consider an example in which the primary object is a “jacket” and the selected content element 208 is a brand logo of a fashion brand. In this example, the prompt 216 additionally includes an instruction to generate the jacket in accordance with a style of the particular fashion brand, and as such, the jacket (e.g., the selected content element 208) is generated in the style of the fashion brand.

As shown, the generated content 134 is provided to a validation module 218, which is configured to control output of the generated content 134 based on whether the generated content satisfies an image quality threshold 220. To do so, the validation module 218 uses an image quality scoring algorithm to determine an image quality score for the generated content 134. As part of this, the generative AI model 136 is configured to generate an image of the generated content 134, and a duplicate image of the generated content 134 that does not include the content elements embedded thereon. Given this, the image quality scoring algorithm considers a peak signal-to-noise ratio (PSNR) which compares a first image (e.g., the image of the generated content 134) to a second image (e.g., the duplicated image that excludes the selected content elements 208) to determine an amount of noise or distortion is present in the first image. Additionally or alternatively, the image scoring algorithm considers a structural similarity index measure (SSIM) which measures a human-perceived similarity between a first image (e.g., the image of the generated content 134) to a second image, e.g., the duplicated image that excludes the selected content elements 208. In various examples, the image quality scoring algorithm considers an inception score for an image of the generated content 134, which measures quality and diversity of images generated by the generative AI model.

Additionally or alternatively, the image scoring algorithm leverages a visual saliency model, which is configured to produce a visual saliency map of an image of the generated content 134. A visual saliency map captures degrees of fixation by human observers on corresponding portions of an image. For example, brighter regions of the visual saliency map correspond to areas of the image that are more visually prominent, while darker regions of the visual saliency map correspond to areas of the image that are less visually prominent. In one or more examples, brightness is measured in luminance on a scale between zero and two-hundred fifty-five. Here, a particular degree of fixation is desired for the content elements embedded on the primary object 132. Indeed, it is desirable for the embedded content element to be noticed by the user 122, but not to distract the user 122 from the remainder of the generated content 134. Accordingly, a preferred value of luminance is specified (e.g., more than zero but less than two-hundred fifty-five), and an exhibited value of luminance is determined for the region of the visual saliency map corresponding to the selected content element 208. The image quality score is based on how close the exhibited value of luminance is to the preferred value of luminance, e.g., with closer scores being assigned higher image quality scores.

Accordingly, the image scoring algorithm generates an image quality score for the generated content 134 using PSNR, SSIM, inception score, and/or visual saliency maps. Next, the validation module 218 compares the image quality score to the image quality threshold, e.g., a threshold value for the image quality score. If the image quality score satisfies the image quality threshold 220, then the generated content 134 is output for display in the user interface 120, as shown. If, however, the image quality score does not satisfy the image quality threshold 220, then the validation module 218 causes the content embedding system 130 to iteratively re-produce different generated content 134 until generated content 134 is produced that satisfies the image quality threshold 220. In the following discussion, consider an example of generated content 134 having one primary object 132 and one selected content element 208 embedded on the selected placement 210 of the primary object 132

During one or more first iterations, the validation module 218 instructs the model prompting module 214 to re-prompt the generative AI model 136 on the same input. In other words, the model prompting module 214, during the first iterations, prompts the generative AI model 136 to generate content in accordance with the content generation query 138 while embedding the same selected content element 208 on the same selected placement 210 of the primary object 132. During each iteration, the generated content 134 is assigned an image quality score, which is compared against the image quality threshold 220. If the image quality threshold 220 is satisfied during a particular first iteration, then the generated content 134 created during the particular first iteration is output for display in the user interface 120.

After a threshold number of the first iterations (e.g., three iterations) have failed to produce generated content 134 that satisfies the image quality threshold 220, the validation module 218 instructs the content selection module 206 to select a different content element (from the retrieved content elements 126) and/or select a different placement on the primary object 132. Thus, during each of the second iterations, the model prompting module 214 prompts the generative AI model 136 to generate content in accordance with the content generation query 138 while embedding a different content element on a different placement of the primary object 132. Notably, different ones of the second iterations embed different content elements 126 on the primary object 132. If the image quality threshold 220 is satisfied during a particular second iteration, then the generated content 134 created during the particular second iteration is output for display in the user interface 120.

After a threshold number of the second iterations (e.g., three iterations) have failed to produce generated content 134 that satisfies the image quality threshold 220, the validation module 218 instructs the model prompting module to re-prompt the generative AI model 136 to generate content without a content element 126 from the content database 124. For example, the model prompting module 214 instructs the generative AI model 136 to generate content based on the content generation query 138 without imposing an instruction to embed a content element 126 on the primary object 132. Here, the generated content 134 that does not include a content element 126 from the content database 124 is output for display in the user interface 120 regardless of image quality score.

In one or more implementations, the user 122 provides feedback via user input to the user interface 120 with respect to the generated content 134. In one example, the content embedding system 130 displays a prompt in the user interface 120 along with the generated content 134. Here, the prompt asks whether the selected content element 208 is relevant to the user 122. If the user 122 provides positive feedback (i.e., the user 122 indicates that the selected content element 208 is relevant), then no further action is taken. However, if the user 122 provides negative feedback (i.e., the user 122 indicates that the selected content element 208 is not relevant), then the content selection module 206 is configured to select a different content element (from the retrieved content elements 126) to embed on the primary object 132. Furthermore, the model prompting module 214 prompts the generative AI model 136 to generate content in accordance with the content generation query 138 while embedding a different content element on the primary object 132.

Additionally or alternatively, the feedback provided by the user 122 is usable to further train and/or refine the machine learning model implemented by the content selection module 206. In response to receiving the positive feedback from the user 122, for instance, the content embedding system 130 positively reinforces (e.g., rewards) the machine learning model. Alternatively, the content embedding system 130 negatively reinforces (e.g., penalizes) the machine learning model in response to receiving the negative feedback from the user 122. In this way, the machine learning model continues to learn (e.g., using reinforcement learning) how to select relevant and appropriate content elements for users during deployment, which improves content element selection accuracy.

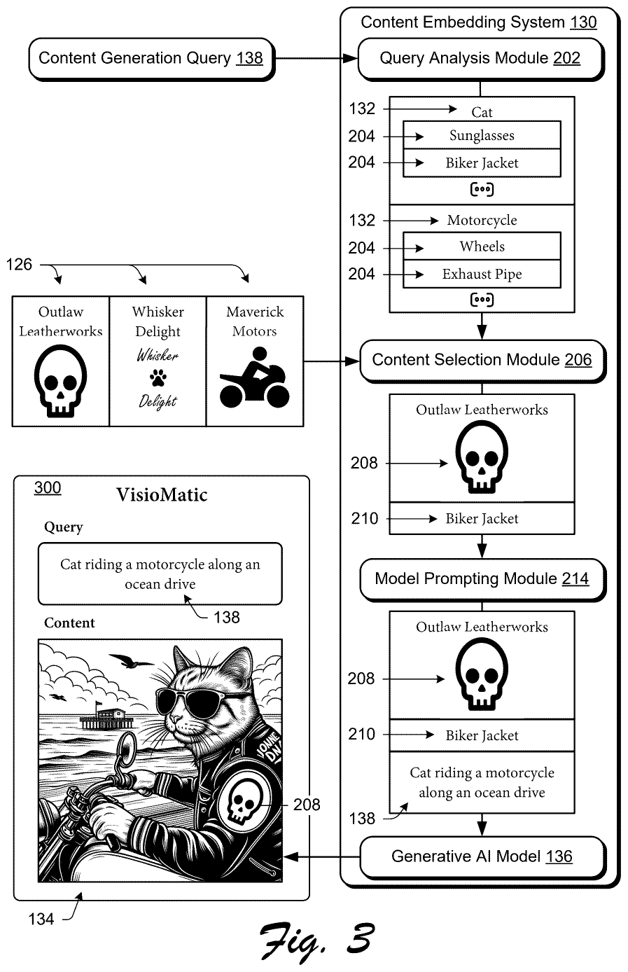

FIG. 3 depicts an example user interface 300 of embedding content on a primary object of generated content. As shown, the user 122 provides a content generation query 138 via the user interface 300 “cat riding a motorcycle along an ocean drive.” The content generation query is provided to the query analysis module 202, which extracts the primary objects 132 and candidate placements 204 thereon. Here, the content generation query 138 includes two primary objects 132 “cat” and “motorcycle.” The candidate placements 204 for “cat” include the primary object 132 itself, as well as components that the cat can be made to wear, such as “sunglasses” and “biker jacket.” Further, the candidate placements 204 for “motorcycle” include the primary object 132 itself, as well as components of the motorcycle, such as “wheels” and “exhaust pipe.”

As shown, the content selection module 206 retrieves a plurality of content elements 126 including brand logos of a plurality of brands, e.g., Outlaw Leatherworks, Whisker Delight, and Maverick Motors. For example, the clothing brand “Outlaw Leatherworks” is paired with the tag “biker jacket” in the content database 124, the cat food brand “Whisker Delights” is paired with the tag “cat” in the content database 124, and the motorcycle brand “Maverick Motors” is paired with the tag “motorcycle” in the content database 124. Here, the content selection module 206 outputs, from the retrieved content elements 126, a selected content element 208, e.g., the brand logo of “Outlaw Leatherworks.” In one example, the clothing brand is selected over the motorcycle brand and the cat food brand based on the user interests of the user data 128 indicating a stronger interest of the user 122 in “fashion,” as compared to “automobiles,” and “pets.” Additionally or alternatively, “Outlaw Leatherworks” is chosen based on the environmental context 212 associated with the user 122 indicating that the user is within a threshold radius (e.g., five miles) of a brick-and-mortar store associated with the clothing brand and/or the clothing brand is offering a promotion, e.g., buy one get one free. Additionally or alternatively, “Outlaw Leatherworks” is chosen based on brand information of “Outlaw Leatherworks” indicating a sponsorship with an organization that the user 122 has expressed an interest in based on the user data 128. In addition, the content selection module 206 outputs the “biker jacket” as the selected placement 210 on the primary object 132, e.g., based on a degree of relevance of the biker jacket to the clothing brand “Outlaw Leatherworks.”

Next, the model prompting module 214 builds a prompt to feed to the generative AI model 136. The prompt includes the selected content element 208, the selected placement 210 on the primary object 132, and the content generation query 138. As shown, the generative AI model 136 creates generated content 134 based on the prompt by embedding the selected content element 208 (e.g., the brand logo of Outlaw Leatherworks) on the selected placement 210 (e.g., the biker jacket) of the primary object 132, e.g., the cat.

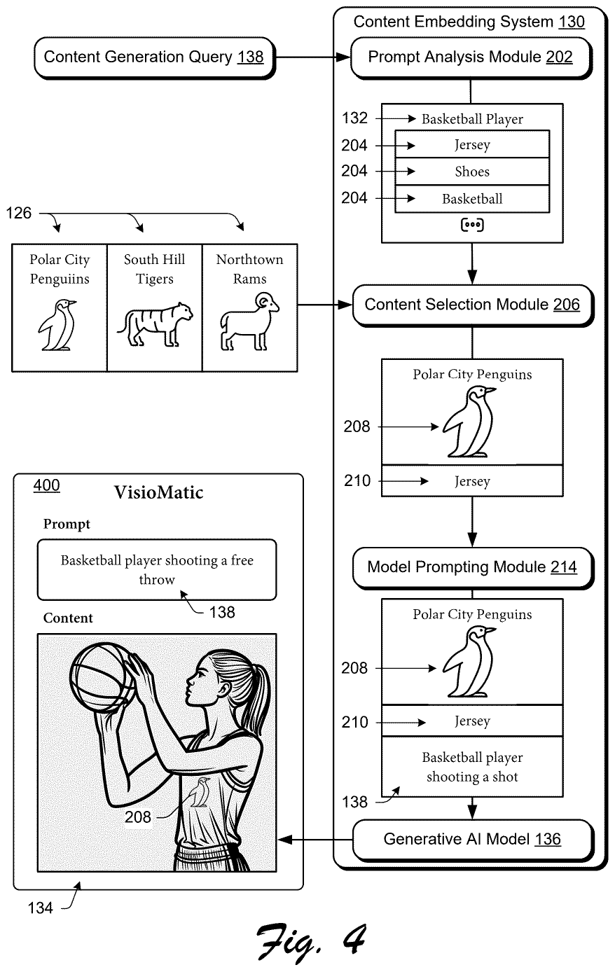

FIG. 4 depicts an example user interface 400 of embedding content on a primary object of generated content. As shown, the user 122 provides a content generation query 138 via the user interface 400 “basketball player shooting a free throw.” The content generation query is provided to the query analysis module 202, which extracts the primary object 132 and candidate placements 204 thereon. Here, the primary object 132 is “basketball player,” and the candidate placements 204 include the basketball player as a whole and components of the basketball player, such as “jersey,” “shoes,” and “basketball”

As shown, the content selection module 206 retrieves a plurality of content elements 126 including team logos of professional basketball teams, e.g., “Polar City Penguins,” “South Hill Tigers,” and “Northtown Rams.” These content elements 126, for instance, are paired with the tag “basketball” in the content database. Here, the content selection module 206 outputs a selected content element 208, e.g., a team logo of “Polar City Penguins.” In one example, a women's basketball team is chosen based on the user data indicating that the user 122 is a woman. Additionally or alternatively, the team “Polar City Penguins” is chosen based on the environmental context 212 of the user 122 indicating that the Polar City Penguins play a game within a certain time frame (e.g., within the next twelve hours) and that the user 122 is within a certain distance radius (e.g., ten miles) from a stadium where the Polar City Penguins play. Additionally or alternatively, the team “Polar City Penguins” is selected based on the user having shown an interest in the team, e.g., in the user interests of the user data 128. The selection module 206 further outputs the “jersey” as the selected placement 210 on the primary object 132, e.g., based on a degree of relevance of a basketball jersey with respect to a professional basketball team.

Next, the model prompting module 214 builds a prompt to feed to the generative AI model 136. The prompt includes the selected content element 208, the selected placement 210 on the primary object 132, and the content generation query 138. As shown, the generative AI model 136 creates generated content 134 based on the prompt by embedding the selected content element 208 (e.g., the team logo of the Polar City Penguins) on the selected placement 210 (e.g., the jersey) of the primary object 132, e.g., the basketball player.

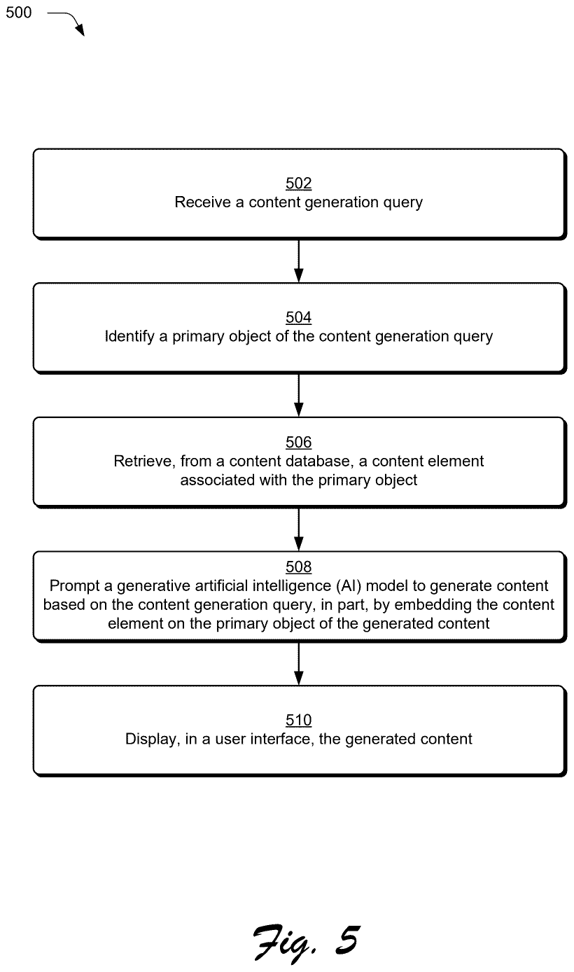

FIG. 5 illustrates a flow chart depicting an example method 500 of embedding content on a primary object of generated content in accordance with one or more implementations. In one or more implementations, the operations of the method 500 are implemented by the device 102. At 502, a content generation query is received. For example, the user 122 provides input via the user interface 120 specifying a content generation query 138, which is received by the content embedding system 130a. At 504, a primary object of the content generation query is identified. By way of example, the query analysis module 202 of the content embedding system 130a analyzes the content generation query 138 to identify a primary object 132 of the content generation query 138.

At 506, a content element associated with the primary object is retrieved from a content database. For instance, the query analysis module 202 of the content embedding system 130a identifies one or more candidate placements 204 for the primary object 132. The candidate placements 204 include the primary object 132 as a whole, component parts of the primary object 132, and/or optionally integrable components of the primary object 132. Furthermore, the content selection module 206 of the content embedding system 130a retrieves a plurality of content elements 126 associated with the candidate placements 204 from the content database 124. In the context of branded content elements 126, the retrieved data additionally includes brand information of corresponding brands associated with the branded content elements 126. In addition, the content selection module 206 retrieves user data 128 associated with the user 122, and obtains an environmental context 212 of the user 122. Based on the brand information, the user data 128, the environmental context 212, and/or degrees of relevance of the retrieved content elements 126 with respect to the content generation query 138, the content selection module 206 outputs the selected content element 208. In addition, the content selection module 206 outputs a selected placement 210 on the primary object 132 on which to embed the selected content element 208. The selected placement 210 is one of the candidate placements exhibiting a highest degree of relevance to the selected content element 208.

At 508, a generative artificial intelligence (AI) model is prompted to generate content based on the content generation query, in part, by embedding the content element on the primary object of the generated content. For example, the model prompting module 214 of the content embedding system 130a generates a prompt 216. Here, the prompt instructs the generative AI model 136 to generate content in accordance with the content generation query 138 by embedding the selected content element 208 on the selected placement 210 of the primary object 132. In one or more implementations, prompting the generative AI model 136 includes feeding the prompt 216 to an instance of the generative AI model 136 that is local to the device 102. Alternatively, prompting the generative AI model 136 includes communicating the prompt 216 to the additional device 104. Here, an instance of the generative AI model 136 at the additional device 104 produces the generated content 134, and the additional device 104 communicates the generated content 134 back to the device 102. At 510, the generated content is displayed in a user interface. For instance, the device 102 displays the generated content 134 in the user interface 120.

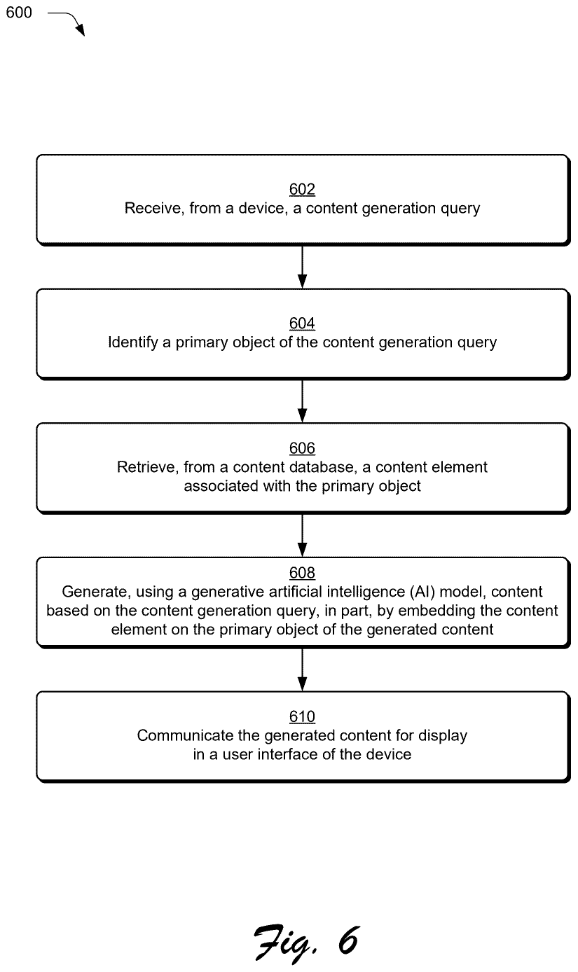

FIG. 6 illustrates a flow chart depicting an example method 600 of embedding content on a primary object of generated content in accordance with one or more implementations. In one or more implementations, the operations of the method 600 are implemented by the additional device 104. At 602, a content generation query is received from a device. For example, the user 122 provides input via the user interface 120 specifying a content generation query 138. The device 102 communicates the content generation query 138 to the additional device 104, which is received by the content embedding system 130b. At 604, a primary object of the content generation query is identified. By way of example, the query analysis module 202 of the content embedding system 130b analyzes the content generation query 138 to identify a primary object 132 of the content generation query 138.

At 606, a content element associated with the primary object is retrieved from a content database. For instance, the query analysis module 202 of the content embedding system 130b identifies one or more candidate placements 204 for the primary object 132. The candidate placements 204 include the primary object 132 as a whole, component parts of the primary object 132, and/or optionally integrable components of the primary object 132. Furthermore, the content selection module 206 of the content embedding system 130b retrieves a plurality of content elements 126 associated with the candidate placements 204 from the content database 124. In the context of branded content elements 126, the retrieved data additionally includes brand information of corresponding brands associated with the branded content elements 126. In addition, the content selection module 206 retrieves user data 128 associated with the user 122, and obtains an environmental context 212 of the user 122. Based on the brand information, the user data 128, the environmental context 212, and/or degrees of relevance of the retrieved content elements 126 with respect to the content generation query 138, the content selection module 206 outputs the selected content element 208. In addition, the content selection module 206 outputs a selected placement 210 on the primary object 132 on which to embed the selected content element 208. The selected placement 210 is one of the candidate placements exhibiting a highest degree of relevance to the selected content element 208.

At 608, content is generated using a generative artificial intelligence (AI) model based on the content generation query, in part, by embedding the content element on the primary object of the generated content. For example, the model prompting module 214 of the content embedding system 130b generates a prompt 216. Based on the prompt 216, an instance of the generative AI model 136 at the additional device 104 generates content in accordance with the content generation query 138 by embedding the selected content element 208 on the selected placement 210 of the primary object 132. At 610, the generated content is communicated for display in a user interface of the device. For example, the additional device 104 communicates the generated content 134 to the device 102, which displays the generated content 134 in the user interface 120.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 7 illustrates various components of an example device 700 in which aspects of embedding content on a primary object of generated content can be implemented. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of computer, consumer, and/or electronic device. For example, the device 102, the additional device 104, and/or the remote service provider system as shown and described with reference to FIGS. 1-6 may be implemented as the example device 700.

The device 700 includes communication transceivers 702 that enable wired and/or wireless communication of device data 704 with other devices. The device data 704 can include any of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications 714 may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes a content embedding system 718 that implements aspects of embedding content on a primary object of generated content and may be implemented with hardware components and/or in software as one of the device applications 714. For example, the content embedding system 718 can be implemented as the content embedding system 130 described in detail above. In implementations, the content embedding system 718 may include independent processing, memory, and logic components as a computing and/or electronic device integrated with the device 700.

In this example, the example device 700 also includes a camera 720 and sensors 722. The sensors, for instance, may include motion sensors such as may be implemented in an inertial measurement unit (IMU). The motion sensors can be implemented with various sensors, such as a gyroscope, an accelerometer, and/or other types of motion sensors to sense motion of the device. The various motion sensors may also be implemented as components of an inertial measurement unit in the device. Additionally or alternatively, the sensors include global positioning system (GPS) sensors for location tracking.

The device 700 also includes a wireless module 724, which is representative of functionality to perform various wireless communication tasks. The device 700 can also include one or more power sources 726, such as when the device is implemented as a mobile device. The power sources 726 may include a charging and/or power system, and can be implemented as a flexible strip battery, a rechargeable battery, a charged super-capacitor, and/or any other type of active or passive power source.

The device 700 also includes an audio and/or video processing system 728 that generates audio data for an audio system 730 and/or generates display data for a display system 732. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 734. In implementations, the audio system and/or the display system are integrated components of the example device. Alternatively, the audio system and/or the display system are external, peripheral components to the example device.

Although implementations of embedding content on a primary object of generated content have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:
In some aspects, the techniques described herein relate to a system comprising at least one memory, and at least one processor coupled with the at least one memory and configured to cause the system to receive a content generation query, identify a primary object of the content generation query, retrieve, from a content database, a content element associated with the primary object, prompt a generative artificial intelligence (AI) model to generate content based on the content generation query, in part, by embedding the content element on the primary object of the generated content, and display, in a user interface, the generated content.

In some aspects, the techniques described herein relate to a system, wherein the at least one processor is configured to cause the system to identify candidate placements on the primary object where content elements are embeddable, retrieve, from the content database, a plurality of content elements associated with the candidate placements, and select the content element from the plurality of content elements.

In some aspects, the techniques described herein relate to a system, wherein the candidate placements include the primary object as a whole and components of the primary object.

In some aspects, the techniques described herein relate to a system, wherein the content element is selected based on at least one of an environmental context associated with a user submitting the content generation query, a degree of relevance of the content element with respect to the content generation query, or user data describing one or more of interests, preferences, or demographics of the user.

In some aspects, the techniques described herein relate to a system, wherein the content element corresponds to branded content of a brand, and the content element is selected based on at least one of promotions offered by the brand, alignment of the content generation query with a brand voice of the brand, endorsements of the brand, campaign objectives of the brand, and sponsorships of the brand.

In some aspects, the techniques described herein relate to a system, wherein the at least one processor is configured to cause the system to select a particular placement of the candidate placements on which to embed the content element, the particular placement selected based on a degree of relevance of the content element with respect to the particular placement, and prompt the generative AI model to generate the content, in part, by embedding the content element on the particular placement of the primary object.

In some aspects, the techniques described herein relate to a system, wherein the at least one processor is configured to cause the system to iteratively prompt the generative AI model over one or more first iterations to generate the content, in part, by embedding the content element on the primary object of the generated content until the generated content satisfies a content quality threshold.

In some aspects, the techniques described herein relate to a system, wherein the at least one processor is configured to cause the system to iteratively prompt, responsive to a threshold number of the first iterations having failed to generate the content that satisfies the content quality threshold, the generative AI model over one or more second iterations to generate the content, in part, by embedding a different content element from the content database on the primary object of the generated content until the generated content satisfies the content quality threshold.

In some aspects, the techniques described herein relate to a system, wherein the at least one processor is configured to cause the system to prompt, responsive to the threshold number of the second iterations having failed to generate the content that satisfies the content quality threshold, the generative AI model to generate the content without a content element from the content database.

In some aspects, the techniques described herein relate to a system, wherein the at least one processor is configured to cause the system to generate a prompt that includes the content generation query, an indication of the primary object, and the content element, communicate the prompt to an additional device that includes the generative AI model, and receive the generated content from the additional device.

In some aspects, the techniques described herein relate to a mobile device comprising at least one memory, and at least one processor coupled with the at least one memory and configured to cause the mobile device to receive a content generation query, identify a primary object of the content generation query, retrieve, from a content database, a content element associated with the primary object, generate content based on the content generation query, in part, by embedding the content element on the primary object of the generated content, and display, in a user interface, the generated content.

In some aspects, the techniques described herein relate to a mobile device, wherein the at least one processor is configured to cause the mobile device to identify candidate placements on the primary object where content elements are embeddable, retrieve, from the content database, a plurality of content elements associated with the candidate placement, and select the content element from the plurality of content elements.

In some aspects, the techniques described herein relate to a mobile device, wherein the candidate placements include the primary object as a whole and components of the primary object.

In some aspects, the techniques described herein relate to a mobile device, wherein the content element is selected based on at least one of an environmental context associated with a user submitting the content generation query, a degree of relevance of the content element with respect to the content generation query, or user data describing one or more of interests, preferences, or demographics of the user.

In some aspects, the techniques described herein relate to a mobile device, wherein the at least one processor is configured to cause the mobile device to select a particular placement of the candidate placements on which to embed the content element, the particular placement selected based on a degree of relevance of the content element with respect to the particular placement, and generate the content, in part, by embedding the content element on the particular placement of the primary object.

In some aspects, the techniques described herein relate to a mobile device, wherein the at least one processor is configured to cause the mobile device to receive user feedback with respect to the generated content, retrieve, from the content database, a different content element associated with the primary object based on the user feedback, generate additional content based on the content generation query, in part, by embedding the different content element on the primary object of the additional content, and display, in the user interface, the additional content.

In some aspects, the techniques described herein relate to a method implemented by a first device, the method comprising receiving, from a second device, a content generation query, identifying a primary object of the content generation query, retrieving, from a content database, a content element associated with the primary object, generating, using a generative artificial intelligence (AI) model, content based on the content generation query, in part, by embedding the content element on the primary object of the generated content, and communicating the generated content for display in a user interface of the second device.

In some aspects, the techniques described herein relate to a method, wherein generating the content includes iteratively prompting the generative AI model over one or more first iterations to generate the content, in part, by embedding the content element on the primary object of the generated content until the generated content satisfies a content quality threshold.

In some aspects, the techniques described herein relate to a method, wherein generating the content further includes iteratively prompting, responsive to a threshold number of the first iterations having failed to generate the content that satisfies the content quality threshold, the generative AI model over one or more second iterations to generate the content, in part, by embedding a different content element from the content database on the primary object of the generated content until the generated content satisfies the content quality threshold.

In some aspects, the techniques described herein relate to a method, wherein generating the content further includes prompting, responsive to the threshold number of the second iterations having failed to generate the content that satisfies the content quality threshold, the generative AI model to generate the content without a content element from the content database.

What is claimed is:

1. A system comprising:
at least one memory; and
at least one processor coupled with the at least one memory and configured to cause the system to:
receive a content generation query;
identify a primary object of the content generation query;
retrieve, from a content database, a content element associated with the primary object;
prompt a generative artificial intelligence (AI) model to generate content based on the content generation query, in part, by embedding the content element on the primary object of the generated content; and
display, in a user interface, the generated content.

2. The system of claim 1, wherein the at least one processor is configured to cause the system to:
identify candidate placements on the primary object where content elements are embeddable;
retrieve, from the content database, a plurality of content elements associated with the candidate placements; and
select the content element from the plurality of content elements.

3. The system of claim 2, wherein the candidate placements include the primary object as a whole and components of the primary object.

4. The system of claim 2, wherein the content element is selected based on at least one of an environmental context associated with a user submitting the content generation query, a degree of relevance of the content element with respect to the content generation query, or user data describing one or more of interests, preferences, or demographics of the user.

5. The system of claim 2, wherein the content element corresponds to branded content of a brand, and the content element is selected based on at least one of promotions offered by the brand, alignment of the content generation query with a brand voice of the brand, endorsements of the brand, campaign objectives of the brand, and sponsorships of the brand.

6. The system of claim 2, wherein the at least one processor is configured to cause the system to:
select a particular placement of the candidate placements on which to embed the content element, the particular placement selected based on a degree of relevance of the content element with respect to the particular placement; and
prompt the generative AI model to generate the content, in part, by embedding the content element on the particular placement of the primary object.

7. The system of claim 1, wherein the at least one processor is configured to cause the system to iteratively prompt the generative AI model over one or more first iterations to generate the content, in part, by embedding the content element on the primary object of the generated content until the generated content satisfies a content quality threshold.

8. The system of claim 7, wherein the at least one processor is configured to cause the system to iteratively prompt, responsive to a threshold number of the first iterations having failed to generate the content that satisfies the content quality threshold, the generative AI model over one or more second iterations to generate the content, in part, by embedding a different content element from the content database on the primary object of the generated content until the generated content satisfies the content quality threshold.

9. The system of claim 8, wherein the at least one processor is configured to cause the system to prompt, responsive to the threshold number of the second iterations having failed to generate the content that satisfies the content quality threshold, the generative AI model to generate the content without a content element from the content database.

10. The system of claim 1, wherein the at least one processor is configured to cause the system to:
generate a prompt that includes the content generation query, an indication of the primary object, and the content element;
communicate the prompt to an additional device that includes the generative AI model; and
receive the generated content from the additional device.

11. A mobile device comprising:
at least one memory; and
at least one processor coupled with the at least one memory and configured to cause the mobile device to:
receive a content generation query;
identify a primary object of the content generation query;
retrieve, from a content database, a content element associated with the primary object;
generate content based on the content generation query, in part, by embedding the content element on the primary object of the generated content; and
display, in a user interface, the generated content.

12. The mobile device of claim 11, wherein the at least one processor is configured to cause the mobile device to:
identify candidate placements on the primary object where content elements are embeddable;
retrieve, from the content database, a plurality of content elements associated with the candidate placements; and
select the content element from the plurality of content elements.

13. The mobile device of claim 12, wherein the candidate placements include the primary object as a whole and components of the primary object.

14. The mobile device of claim 12, wherein the content element is selected based on at least one of an environmental context associated with a user submitting the content generation query, a degree of relevance of the content element with respect to the content generation query, or user data describing one or more of interests, preferences, or demographics of the user.

15. The mobile device of claim 12, wherein the at least one processor is configured to cause the mobile device to:
select a particular placement of the candidate placements on which to embed the content element, the particular placement selected based on a degree of relevance of the content element with respect to the particular placement; and
generate the content, in part, by embedding the content element on the particular placement of the primary object.

16. The mobile device of claim 11, wherein the at least one processor is configured to cause the mobile device to:
receive user feedback with respect to the generated content;
retrieve, from the content database, a different content element associated with the primary object based on the user feedback;
generate additional content based on the content generation query, in part, by embedding the different content element on the primary object of the additional content; and
display, in the user interface, the additional content.

17. A method implemented by a first device, the method comprising:
receiving, from a second device, a content generation query;
identifying a primary object of the content generation query;
retrieving, from a content database, a content element associated with the primary object;
generating, using a generative artificial intelligence (AI) model, content based on the content generation query, in part, by embedding the content element on the primary object of the generated content; and
communicating the generated content for display in a user interface of the second device.

18. The method of claim 17, wherein generating the content includes iteratively prompting the generative AI model over one or more first iterations to generate the content, in part, by embedding the content element on the primary object of the generated content until the generated content satisfies a content quality threshold.

19. The method of claim 18, wherein generating the content further includes iteratively prompting, responsive to a threshold number of the first iterations having failed to generate the content that satisfies the content quality threshold, the generative AI model over one or more second iterations to generate the content, in part, by embedding a different content element from the content database on the primary object of the generated content until the generated content satisfies the content quality threshold.

20. The method of claim 19, wherein generating the content further includes prompting, responsive to the threshold number of the second iterations having failed to generate the content that satisfies the content quality threshold, the generative AI model to generate the content without a content element from the content database.
